(19) United States
(12) Patent Application Publication
(10) Pub. No.: US 2015/0115848 A1
(43) Pub. Date: Apr. 30, 2015

(54) ELECTRIC LINEAR ACTUATOR

(71) Applicant: IRIS DYNAMICS LTD., Victoria (CA)

(72) Inventor: Patrick A. McFADDEN, Victoria (CA)

(21) Appl. No.: 14/525,372

(22) Filed: Oct. 28, 2014

Related U.S. Application Data
(60) Provisional application No. 61/935,396, filed on Feb. 4, 2014.

(30) Foreign Application Priority Data
Oct. 28, 2013 (CA) 2831197

(51) Int. Cl. H02P 25/06

(52) U.S. Cl. CPC H02P 25/06
USPC 318/135

(57) ABSTRACT

An electric linear actuator includes a linear array of poloidal electrical cods. The central openings of each of the coils are coaxially aligned to define a central bore for the linear array. A shaft is received within and is movable along the central bore of the linear array. Magnets are affixed at spaced intervals along the shaft. A power source provides power to each of the coils of the linear array. Position sensors are provided for determining the axial position of the shaft along the central bore. A control processor receives position data from the position sensors and controls the application of power from the power source to each of the coils in the linear array. The control processor selectively activates the electrical coils to cause variable application of force on the shaft through electro-magnet attraction or repulsion.

This application claims priority from Canadian patent application serial no. 2,831,197 filed Oct. 28, 2013 and the benefit of U.S. provisional application Ser. No. 61/935,396 filed Feb. 4, 2014.

### FIELD

There is described an electric linear actuator that was developed to meet the needs of the flight simulator industry; this electric linear actuator can be used in other industries where linear actuators or other haptic control feedback devices are used.

### BACKGROUND

Current electric linear actuators impart forces onto the medium they are actuating in one of two distinct ways: through use of an electric motor, or through use of a voice coil and a large permanent magnet. The former method of imparting forces relies on a mechanical linkage between a finite-poll motor and the medium that is being actuated. The latter method involves massive and expensive permanent magnets and introduces limitations to the range of motion available. There exists a need for a form of electronic linear force actuation that is both free of physical linkage, while also being free of the constraints involved in traditional voice coil technology. Such technology would fill the growing needs of several industries, including but not limited to: applications in aerospace (remotely piloted aerial vehicles), heavy equipment simulators and controls, military vehicle simulator, marine and remotely piloted vessels/submersibles, automotive and self-driving cars, industrial controls, and robotics. More generally, applications requiring an interface between some being (most notably a human) and technology can benefit from this technology for the reasons outlined in the following text.

A specific area requiring improvements in linear actuation is commercial and home-use flight simulation. Reproducing the forces observed in an actual aircraft are an integral part of training pilots in a simulator, and creating the realism sought out by enthusiasts and certification agencies alike. Existing technologies range in price and complexity. Lower end products fail to provide any feedback aside from a mechanically centring spring which will not vary with simulated conditions such as airspeed or trim settings. Mid range products that feature electronic handle actuation rely on electric motors that are mechanically linked to the handle. Highly specialized systems do exist that use voice coil actuation but they are cost-prohibitive for small to medium training facilities and home users.

Mechanical linkage between actuator and the medium being actuated is problematic for two main reasons: fidelity of sensations on the medium and reliability and service requirements in time. When a medium, for example a control yoke for a flight simulator, is physically connected to an actuator, any force imparted on said control yoke must also be applied to the actuator and the linkage between the two. When the actuator is an electric motor (as an example), it must be turned over as the device is pushed and pulled. As well, any friction present in the linkage will also be felt. The resulting interference degrades tactile feelings. Furthermore, mechanical linkages require periodic maintenance and in time, replacement.

Highly specialized flight simulator controls solve the above problems through use of voice coil actuation. This method eliminates the need for a physical connection thus removing the tactile and reliability disadvantages. However, due to the need for a magnet large enough to surround the control yoke, weight and cost become problematic. Range of motion of such a device becomes limited by the size of the magnet being used. While the range of motion of a Cessna 172 control yoke is approximately one (1) linear foot, currently available simulator control units vary in available range motion from about six (6) to nine (9) inches of travel. The physical footprint of such devices is another factor limiting their value in home and small-outfit set-ups.

In light of the limitations of existing technology (tactile feel, range of motion, cost and reliability, to name just a few), there exists an unmet requirement for linear actuation that eliminates all of the mentioned issues.

Flight simulation is used as an example in this document, but it is worth noting that a touchless, simple, compact and cost-effective method of actuating three on a medium can have far reaching benefits in a variety of fields.

### SUMMARY

The linear actuator hereinafter described can be used in the flight simulator industry, and other industries involving industrial gate motors, industrial control haptic feedback systems and industrial levelling Gust as jacks) as some examples.

There is provided an electric linear actuator, which includes a linear array of electrical coils. Each of the electrical coils has a central opening. The central openings of each of the electrical coils are axially aligned to define a central bore for the linear array. A shaft is received within the central bore of the linear array co-axially. The shaft is axially moveable along the central bore. Magnets are affixed at spaced intervals along the shaft relative to the length of the electrical coils. A power source provides power to each of the electrical coils in the linear array. Position sensors are provided for determining the relative and absolute axial position of the shaft along the central bore. A control processor receives position data from the position sensors and controls the application of power from the power source to each of the electrical coils in the linear array. The control processor selectively activates the electrical coils to cause variable application of three on the shaft through electro-magnet attraction or repulsion as a result of magnetic interaction with the magnets affixed to the shaft.

This electric linear actuator makes no contact with the medium that it is actuating; in the context of this document, that medium is a tubular shaft.

This electric linear actuator is of relatively simple construction and, as such, is less prone to failure and requires less maintenance.

Where rotational actuations is desired, a rotational assembly may be provided that engages the shaft with a rotational motor to selectively impart a rotary motion or force to the shaft via the rotational assembly.

In flight simulator applications, a steering yoke is mounted to an end of the shaft. By gripping the steering yoke, a user may move the shaft axially or rotate the shaft. The control processor provides resistance to such movement by selectively activating the rotational motor and selectively activating the electrical coils in response to variables in the simulation environment and the position of the shaft.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a perspective view of a linear actuator.

FIG. 2 is a perspective view of a yoke and track rod from the linear actuator illustrated in FIG. 1.

FIG. 3 is a detailed longitudinal section view of the track rod illustrated in FIG. 2.

FIG. 4 is a perspective view of magnetic cods from the linear actuator illustrated in FIG. 1.

FIG. 5 is a top perspective view of the linear actuator illustrated in FIG. 1.

FIG. 6 is a detailed perspective view locking ring with locking ring rotational arrows from the linear actuator illustrated in FIG. 1.

FIG. 7 is a detailed perspective view of the rear bearing from the linear actuator illustrated in FIG. 1.

### DETAILED DESCRIPTION

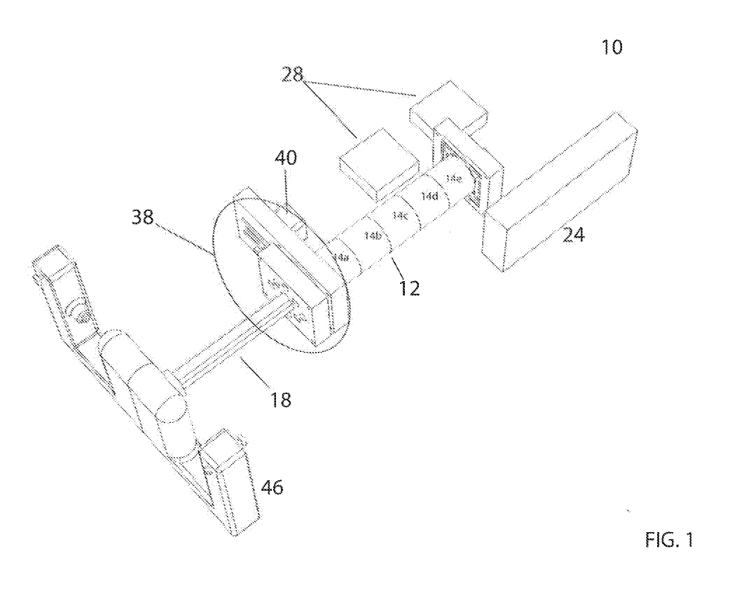

An electric linear actuator, generally identified by reference numeral 10, will now be described with reference to FIG. 1 through FIG. 7.

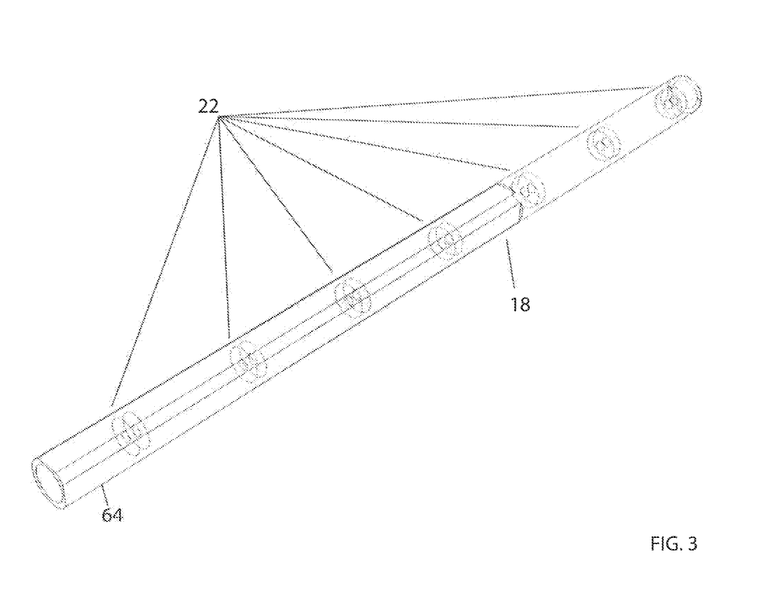

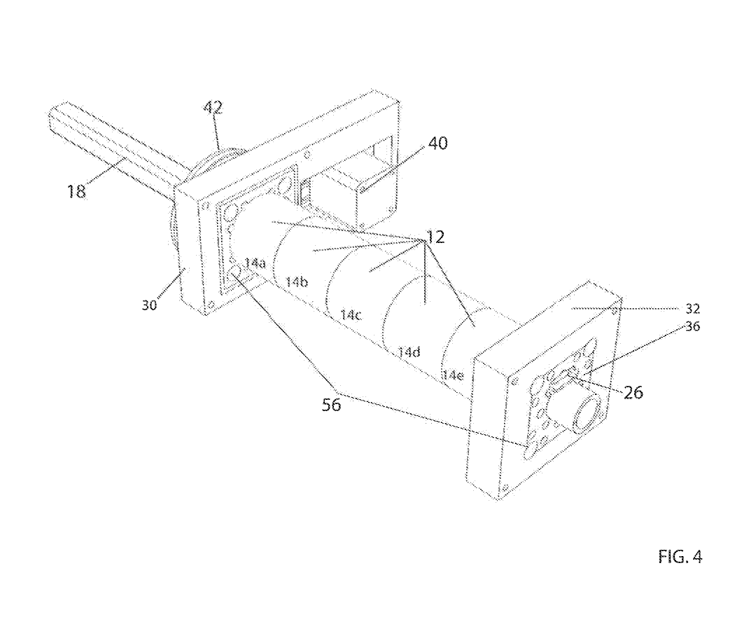

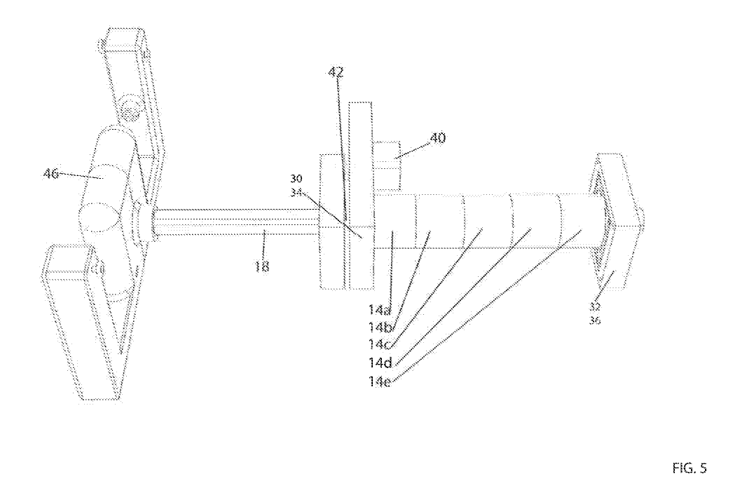

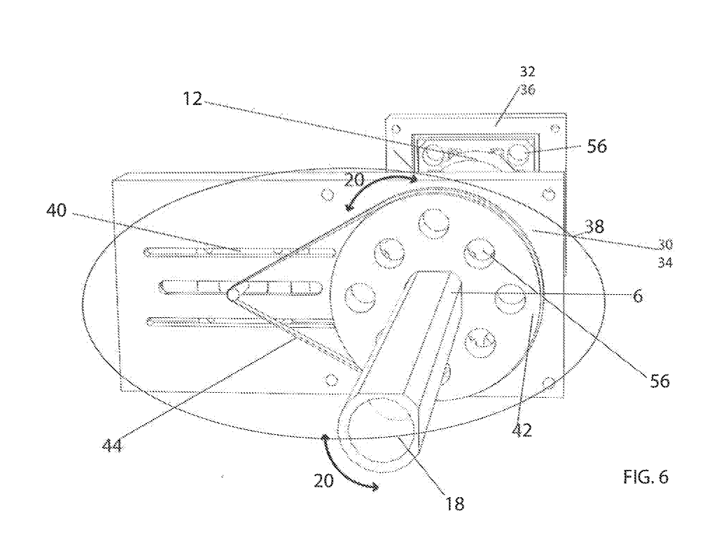

Referring to FIG. 1, electric linear actuator 10 has a linear array 12 of poloidal electrical coils 14. Referring to FIG. 4, electrical coils 14 are individually identified as 14a, 14b, 14c, 14d and 14e. Each of electrical coils 14 has a central opening (not illustrated). Referring to FIG. 6, the central openings of the electrical coil array 12 are co-axially aligned to define a central bore 16 for linear array 12. A shaft 18 is received within central bore 16 of linear array 12. Shaft 18 is axially moveable along central bore 16, axial movement is indicated by two headed arrow 20. Referring to FIG. 3, magnets 22 are positioned at spaced intervals along shall 18. It will be appreciated that magnets 22 could be either permanent magnets or electromagnets, depending upon the intended application. For this application permanent magnets will be illustrated, as will hereinafter be further described. Referring to FIG. 1, there is a power source 24 to provide power to each of the electrical coils 14 of linear array 12. Referring to FIG. 4 and FIG. 6, position sensor 26 is providing for determining the relative axial position of shaft 18 along central bore 16. An optical sensor has been chosen for illustration, it will he understood that alternative sensing technology may be used. A control processor 28 is provided. Control processor 28 receives position data from position sensor 26 regarding the position of shaft 18 along central bore 16 and controls the application of power from power source 24 to each of electrical coils 14 in linear array 12. Control processor 28 selectively activates electrical coils 14 to cause variable application of force on shaft 18 through electro-magnet attraction or repulsion as a result of magnetic interaction of linear array 12 of electrical coils 14 with magnets 22 positioned along shaft 18. It is preferred that control processor 28 be capable of varying power between individual electrical coils 14, such that the power supplied to electrical coils 14 is not homogeneous. This allows the control processor the ability to apply independent voltages to the coils, depending on the required force and the absolute position of the shaft. Referring to FIG. 5, a front shaft support 30 and a rear shaft support 32 are provided for supporting shaft 18. Front shaft support 30 has a front bearing 34 to reduce friction and facilitate movement of shaft 18. Rear shaft support 34 similarly has a rear bearing 36.

The application illustrated in FIG. 1 is a controller for a flight simulator. While axial movement may be sufficient for many applications, for this controller application it is preferred rotational movement also be accommodated. Referring to FIG. 6, a rotational assembly, generally identified by reference numeral 38 that engages shaft 18 and a rotational motor 40 that selectively imparts a rotary motion to shaft 18 via rotational assembly 38. Rotational motor 40 is controlled by control processor 28. Rotational assembly 38 includes a locking ring 42. Locking ring 42 allows linear motion but it does not permit rotational motion. Locking ring 42 acts as a pulley, with rotational motion being imparted via locking ring 42 to shaft 18 by a belt drive 44 that extends from rotational motor 40 to locking ring 42. It is understood that other power transmission techniques such as gears with clutches, direct drive, or chains could be employed in place of a belt drive.

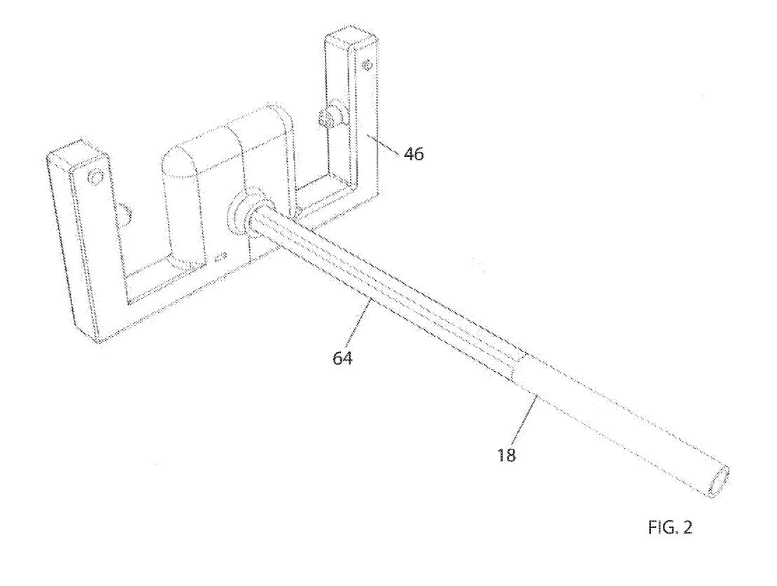

Referring to FIG. 1, a steering yoke 46 is mounted to a remote end 48 of shaft 18. By gripping steering yoke 46, a user may move shaft 18 axially or rotate shaft 18. Control processor 28 provides variable resistance to such movement by selectively activating rotational motor 40 and selectively activating linear array 12 of electrical coils 14. To facilitate this, control processor 26 has an internal logic that governs when control processor 28 should activate rotational motor 40 and when control processor 28 should activate linear array 12 of electrical coils 14. Referring to FIG. 2, there is illustrated steering yoke 46 and shaft 18.

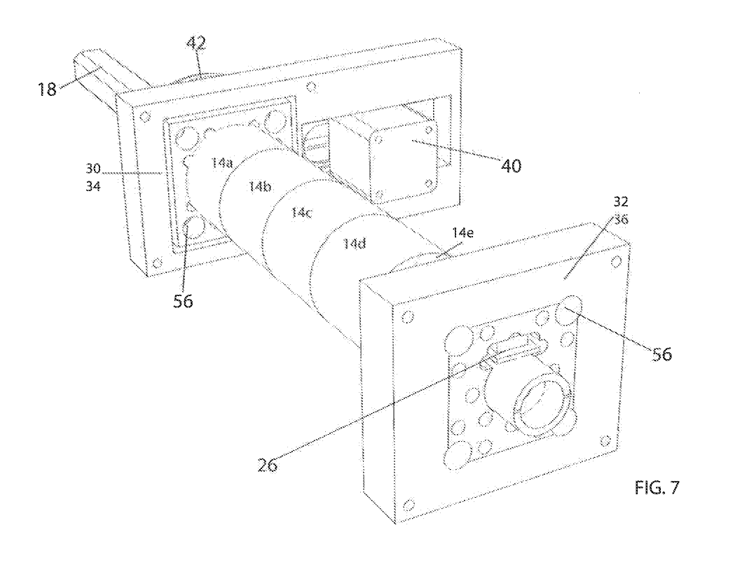

Referring to FIG. 4 and FIG. 7, cooling holes 56 are provided to allow air flow through electric linear actuator 10. Cooling holes 56 illustrated are in front shaft support 30 and a rear shaft support 32.

### Structure and Relationship of Parts

With reference to the drawings, the invention in FIG. 1 shows the overall system architecture and principal subassemblies which comprise:(46)Yoke;(18)Shaft;(14) Magnetic Coils;(24)Power Supply;(28)Processing Unit;(38) Rotational Assembly. Once the system is activated, movement of the Yoke either in the forward/backwards direction or by rotating will result in movement of the Shaft which in turn will be monitored and acted upon by the Processing Unit. The Shaft moves within the Magnetic Coils subassembly (see FIG. 4) which is in turn connected to the Processing Unit for magnetic field activation (power) and control (through pulse width modulation).

FIG. 2 shows the Yoke subassembly comprising the hand-held unit together with a set of buttons and switches. The Shaft is attached to the Yoke itself through a clamp quick-release mechanism. It is understood that other attachment methods may be used to join the Yoke and Shaft assemblies.

FIG. 3 shows, in more detail, the Shaft subassembly. From FIG. 3(18), its length is 629 mm with an external diameter of 1.05″ and an internal diameter of 0.824″. It also shows in FIG. 3(22) the set of spaced poloidal (ring) magnets and spacers within its non-ferrous Shaft (Aluminum). Ring magnets of 0.75″ diameter by 0.25″ thickness are mounted at 3″ intervals along the Shaft and separated by insulating spacers of Acetal Copolymer. Each ring magnet has an internal hole of 0.25″ diameter for cabling routing. The Shaft is shown (see FIG. 3 (64)) with a small vertical groove along its top surface and extending along half of its length from the Yoke end. This groove is associated with the Locking Ring (see FIGS. 5 & 6) for constraining the Shaft in an angular sense and for assisting in causing Shaft rotational movement via a brushless motor on a belt drive and allowing a single (rear mounted) sensor for Shaft movement.

FIG. 4 shows the Magnetic Coils Assembly. FIG. 5(12) shows the five (5) individually wound magnetic coils of 22 AWG copper magnet wire (each of 800 turns) Which delivers 0.098 Tesla at 12 v drive voltage. Each such coil is 2″ external diameter with an internal diameter of 1.5″ and a width of 2″ and includes an embedded temperature sensor. Since the Shaft is 1.05″ diameter, the magnet coils allow for an air gap for ease of Track Rod movement/travel purposes—as shown in FIG. 4(56). FIG. 4(26) shows the slot for mounting of the optical (position) sensor. Embedded within each coil is a temperature sensor. These Magnetic Coils are interfaced to the Processing Unit and Power Supply subassembly through a number of channels per coil, including but not limited to polarity, PWM, and temperature. The flight simulator integration program (resident in the Processing Unit) controls and commands the Magnetic Coils in order to produce the desired motion and feeling associated with the simulator environment to the Magnetic Cobs and thus to the Shaft/Yoke/User. Individual coils are powered on/off/on in a variety of patterns to permit Shaft movement with specific direction and force. Higher force on the Shaft will result both from higher power per coil, the number of coils simultaneously active, and the specific firing pattern of the coils. It is understood that the number of coils in the array and the dimension of each coil could be changed. It is further understood that such changes will impact the spacing of permanent or electro-magnets resident in the Shaft.

FIG. 5 depicts how the Yoke, Shaft and Magnetic Coils subassemblies are integrated. Also, it shows the Locking Ring which is mounted at the front end (nearest the Yoke) which is Teflon and is fixed to the Track Rod. The locking ring allows linear motion but it does not permit rotational motion. Rotational motion is made via linking the locking ring to a brushless motor on a belt drive as shown in FIG. 6 (a ring motor could also be used but is likely cost prohibitive for a consumer device).

FIG. 7 shows the back end of the Magnetic Coils on which sits the rear bearing made of Teflon and which contains an embedded optical sensor contained within a groove in this ring. This optical sensor detects X-axis movement and position of the Track Rod. It is understood that other methods, such as sliding potentiometers or laser distance sensing could he used to determine position of the Track Rod.

Unit cooling is addressed through a single fan concept forcing air through a series of openings in the Locking Ring, Magnetic Coil and Rear Bearing subassemblies. Alternate cooling methods such as liquid cooling could also he employed.

The Processing Subassembly is comprised two primary components, namely the SBC (Single Board Computer), and the PPU (Power Processing Unit). The SBC is an interchangeable off-the-shelf device (such as the Raspberry Pi). The SBC runs a full-fledged OS; in this case Rasphian (a Raspberry port of the open source Linux Debain project) with various functionalities (Ethernet, GPIO, USB, and at least one I2C uplink). The SBCs main function is to interface with the external simulation software, the PPU, the Yokes internal sensors and then to perform all necessary force calculations and information cross feeding. Additionally, the SBC extracts pertinent flight model variables such as airspeed, attitude, altitude, wind, heading, Lat/Long, weight/balance, aircraft configuration, aircraft type, etc via either TCP/IP. The SBC then integrates all of these variables into a force model which is continually updated. Communications functions via TCP/IP or USB connection to the external simulation software are used to send updated pitch/roll and button information, as well as receive simulator environment data. The SBC performs other functions such as hosting a web server which is used to perform configuration changes via a web interface.

The PPU consists of a custom produced PCB (printed circuit board) which includes a dedicated microcontroller (currently an ARM Cortex M4 32-bit RISC) and various power handling circuits. One h-bridge driver for each coil, and one driver for each poll of the brushless DC motor is used. It is understood that there is a possibility for each electric coil to consist of a singular continuous coil, or multiple component coils. In the later case, component coils can be driven by a common driver circuit (one H-Bridge) or by separate circuits (one H-Bridge per component coil). The receives force commands from the SBC via the 12C link protocol (or some other device-to-device communication protocol such as SPI or CAN for example). These commands include instructions for each of the electric coil channels and the electric motor's channels. Dependent on yoke position and values generated from the SBCs force model and lookup-tables, specific magnetic coils will be powered between −100% to 0% to +100%. This will modulate the magnetic fields of each electric coil which will impart force upon the main shaft (via the affixed poloidal magnets' interaction with the electric coils). In this way, resistive force or independent movement (as may he required by the flight model) is produced. The PPU also monitors coil temperature, other pertinent safety variables.

### Variations

The invention includes several novel extensions of the above, unique flight simulator yoke system.

Extension 1: via the SBCs web interface, this invention can also be used to perform software/firmware updates and will offer an avenue for users to upload custom instructions (modifications of lookup-tables etc.).

Extension 2: additionally, the SBC will have two USB jacks remotely mounted in the Yokes hand unit (one internal and one external). The external port will be attached to a power booster so a high amperage device (such as a tablet) if attached can be fully powered. The second internal port can be attached to a device that will broadcast low power “simulated” GPS data to an external device (commercial aviation GPS unit, tablet running aviation navigation software etc). There exists a large market of yoke mounted navigation units in General Aviation. The point of the above mentioned system is to permit users the ability to practice using real navigation software/hardware while “flying” in the virtual environment.

This linear actuator has potential application to: medical devices and industrial automation/control, gate motors, lifting jacks, auto-leveling where such applications require high fidelity in position and three with high MTBF (Mean Time Between Failure) requirements. Additionally, this linear actuator has potential application in: drilling equipment; suspension; industrial manufacturing machinery; antenna extending; locking

### Advantages

This linear actuator will be the first to provide the user with a seamless operational feel unlike currently available simulators based on mechanically-linked actuation. The touchless nature of the actuator ensures there is no interference in the natural movement of the device when no force is intended.

On-board force processing, as well as multiple integrated controllers produce an very low control loop latency and thus superior response time to the simulator's event. Furthermore, local logic enables communication lag detection and sporadic behaviour prevention.

This device's maximum actuated control distance (commonly referred to as throw) is limited only by the length of the shaft and number of affixed magnets used. This is a significant improvement on the design of voice coil motors.

High resolution sensors (9800 dots per inch) result in very accurate position, velocity and acceleration calculations.

Web-Based Access control provided by the embedded microcontroller allows for easy configuration changes and custom configurations, and enables users to share custom aircraft profiles and settings. It also allows provisions for automatic firmware and settings updates. Configuration data is saved to local, non-volatile memory and is thus persistent through loss of power or disconnection to the simulator computer.

Embedded force processing reduces the impact of retarded frame rates in the simulation environment and delays in the communication protocols. It reduces processing strain on the main simulator computer and eliminates the need for extra external computers. As well, local force processing allows realistic simulation of trim functionality, even when this is not supported, or poorly supported by simulator environments and associated plug-ins. Furthermore, the presence of onboard processing eliminates the need for said plug-ins and any other third-party software previously required by the existing force-feedback control devices.

Simplicity of design and required components results in a marked reduction in complexity compared to existing force-actuation technology. Lower costs for production and maintenance will also result from the touchless nature of the actuator; there is no physical link between the external coils and the magnets affixed to the shaft.

Open source software controlling the embedding processing allows a level of customization not currently offered by force feedback simulators controls currently.

This linear actuator enables low cost, high resolution, high MTBF, variable force linear actuators. The innovations in this device can be easily adapted to any environment requiring high resolution variable linear force generation with possible applications in: remotely piloted aerial vehicles, heavy equipment simulators and controls, military vehicle simulators, remotely piloted land/marine/submersible vehicles, automotive and self-driving cars, industrial controls, robotics, medical devices, industrial automation, etc. Its design could be easily adapted for use in harsh environments where premature device failure would be costly such as found in the petrochemical industries, and non-atmospheric applications.

Potential future applications include the use of a GPS broadcast (transmit) subsystem within the yoke assembly for enabling simulator flight functionality into existing mapping applications. Current PC-based flight simulator and yoke products do not support this capability.

This linear actuator is unique in the use of CanBus, UDP and TCP/IP protocols between the yoke and the embedded system (simulator) processing.

The following descriptive terms shall be used synonymously throughout this document as follows: “force feedback” (used principally in the gaming world); “control loading” (used principally in the commercial aviation simulation industry); “haptic feedback” (used principally in the computer/human science field). A “poloidal” coil is doughnut shaped, but differs from a toroidal coil (which is also doughnut shaped) with respect to field direction. A toroidal coil generally has a field lines that “flow” around the outer edges of the “doughnut”. A poloidal coil generally has field lines that “flow” from the front to the back of the “doughnut”. For best results a poloidal coil should be used.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

The scope of the claims should not be limited by the illustrated embodiments set forth as examples, but should be given the broadest interpretation consistent with a purposive construction of the claims in view of the description as a whole.

What is claimed is:

1. An electric linear actuator, comprising:
a linear array of poloidal electrical coils, each of the electrical coils having a central opening, the central openings of each of the electrical coils being axially aligned to define a central bore for the linear array;
a shaft received within the central bore of the linear array, the shaft being axially moveable along the central bore, magnets being affixed at spaced intervals along the shaft;
a power source to provide power to each of the electrical coils of the linear array of electrical coils;
position sensors for determining the axial position of the shaft along the central bore;
a control processor which receives position data from the position sensors and controls the application of power from the power source to each of the electrical coils in the linear array, the control processor selectively activating the electrical coils to cause variable application of force on the shaft through electro-magnet attraction or repulsion as a result of magnetic interaction with the magnets affixed along the shaft.

2. The electric linear actuator of claim 1, wherein the magnets are one of permanent magnets or electromagnets.

3. The electric linear actuator of claim 1, wherein the electrical coils form a master coil,

4. The electric linear actuator of claim 1 where the electrical coils are comprised of multiple independent coils.

5. The electric linear actuator of claim 3 where each electrical coil is driven by a common driver circuit that drives all electrical coils in the master coil.

6. The electric linear actuator of claim 3, wherein there is a separate driver circuit for each electrical coil in the master coil.

7. The electric linear actuator of claim 1, wherein the control processor is capable of varying power between individual electrical coils, such that the power supplied to the electrical coils is not homogeneous.

8. The electric linear actuator of claim 1, wherein the shaft is supported by bearings.

9. The electric linear actuator of claim 1, where the output shaft position and output three is calculated by the control processor, in such a way as to be able to detect the amount of force on the shaft.

10. The electric linear actuator of claim 1, wherein a rotational assembly is provided that engages the shaft and a rotational motor is provided to selectively impart a rotary motion or force to the shaft via the rotational assembly, the rotational motor being controlled by the control processor.

11. electric linear actuator of claim 1, wherein at least one position sensor is used to directly or indirectly detect the angular position of the shaft.

12. The electric linear actuator of claim 1, wherein a yoke, handle, coupling or other manipulator is mounted to a remote end of the shaft whereby by gripping the manipulator, a user may move the shaft axially and wherein the control processor provides variable resistance to such movement.

13. The electric linear actuator of claim 12, where the variable resistance is controlled in such a way as to impart physical information to a human operator or another machine by using shaft position, force, vibration, or other electrical signaling means.

14. electrical linear actuator of claim 12, wherein a wire or cable may be positioned axially within the central bore of the shaft such wire or cable can carry electrical power and signals between the yoke, handle, coupling or other manipulator to the control processor.
